(19) United States
(12) Patent Application Publication
(10) Pub. No.: US 2020/0311802 A1
(43) Pub. Date: Oct. 1, 2020

(54) SYSTEMS, METHODS, AND ARTICLES OF MANUFACTURE FOR PROVIDING FREQUENTLY PURCHASED ITEM RELOCATION INFORMATION TO CUSTOMERS

(71) Applicant: Toshiba Global Commerce Solutions Holdings Corporation, Tokyo (JP)

(72) Inventors: Susan Brosnan, Raleigh, NC (US); Sue Copley, Raleigh, NC (US); Gary Fails, Cary, NC (US); Daniel Bond, Raleigh, NC (US)

(21) Appl. No.: 16/369,558

(22) Filed: Mar. 29, 2019

(51) Int. Cl. G06Q 30/06

(52) U.S. Cl. CPC G06Q 30/0639; G06Q 30/0631

(57) ABSTRACT

A method of operating a shopping notification system may include electronically recognizing a current presence of a customer at a store to provide recognized customer data. A database of previously purchased items of the customer may be accessed using the recognized customer data to provide frequently purchased items information associated with the customer. A category of items including any item in the frequently purchased items information may be determined to have moved within the store in a time between a previous presence of the customer at the store and the current presence of the customer at the store to provide item relocation information and the item relocation information may be electronically provided to the customer.

### FIELD

The present invention relates to the field of information processing in general, and more particularly, to point of sale systems.

### BACKGROUND

It is known for retail outlets, such as grocery stores, to organize items based on categories. It is also known that such stores, from time-to-time, may relocate some categories of items within the store. Frequent customers of the store can be frustrated when they are unable to find those frequently purchased items because the items have been moved.

### SUMMARY

Embodiments according to the invention can provide systems, methods, and articles of manufacture for providing personalized frequently purchased item relocation information to customers. Pursuant to these embodiments, a method of operating a shopping notification system may include electronically recognizing a current presence of a customer at a store to provide recognized customer data. A database of previously purchased items of the customer may be accessed using the recognized customer data to provide frequently purchased items information associated with the customer. A category of items including any item in the frequently purchased items information may be determined to have moved within the store in a time between a previous presence of the customer at the store and the current presence of the customer at the store to provide item relocation information and the item relocation information may be electronically provided to the customer.

In some embodiments, a method of operating an electronic shopping notification system may include electronically recognizing a current presence of a customer at a store during a checkout process to provide recognized customer data, accessing a database of previously purchased items of the customer using the recognized customer data to provide frequently purchased items information associated with the customer, electronically determining that a category of items including any item in the frequently purchased items information is scheduled to be moved within the store after the current presence to provide scheduled item relocation information, and electronically displaying the scheduled item relocation information to the customer.

In some embodiments, a shopping notification system can include an electronic detection system configured to electronically receive data associated with an identity of a customer responsive to a current presence of the customer at a store to provide recognized customer data. A database can be coupled to the electronic detection system and configured to store previously purchased items of the customer accessed using the recognized customer data to provide frequently purchased items information associated with the customer. A processor circuit can be coupled to the database and to the electronic detection system, where the processor circuit can be configured to determine that a category of items including any item in the frequently purchased items information has moved in a time between a previous presence of the customer at the store and the current presence of the customer at the store to provide item relocation information. An electronic notification system can be coupled to the processor circuit and can be configured to provide the item relocation information to the customer.

### BRIEF DESCRIPTION OF THE DRAWINGS

FIGS. 1 to 3 are schematic illustrations of a system configured to provide relocation information for frequently purchased items to a recognized customer in some embodiments according to the invention.

FIG. 4 is a flowchart illustrating methods of operating a system configured to provide relocation information for frequently purchased items to a recognized customer in some embodiments according to the invention.

FIG. 5 is a block diagram of system configured to provide relocation information for frequently purchased items to a recognized customer in some embodiments according to the invention.

### DETAILED DESCRIPTION OF EMBODIMENTS ACCORDING TO THE INVENTIVE CONCEPTS

Exemplary embodiments of the present disclosure are described in detail with reference to the accompanying drawings. The disclosure may, however, be exemplified in many different forms and should not be construed as being limited to the specific exemplary embodiments set forth herein. Rather, these exemplary embodiments are provided so that this disclosure will be thorough and complete, and will fully convey the scope of the disclosure to those skilled in the art.

As appreciated by the present inventors, frequent customers of a store can be frustrated when they are unable to find their frequently purchased items because those items have been moved within the store. Accordingly, methods, systems and articles of manufacture can advise recognized frequent customers that items that they have purchased frequently at that store have been moved. In some embodiments, relocation information for those frequently purchased items can be provided to the recognized customer via an electronic device. The electronic device may be provided by the store, may be a device associated or owned by the customer, or be an in-store device such as a video monitor or audio output device. The information may be text data, image data, video data, and/or audio data. For example, the relocation information may be a graphic that shows a representation of the store layout and depicts the movement of the item from one aisle to another.

In some embodiments, the customer may be recognized as a frequent customer using an established association between the customer's electronic device (such as a mobile phone) and a loyalty program in which the customer has enrolled. In some embodiments, threshold levels can be used to determine whether the customer is a frequent customer of a particular store. In other embodiments, a customer can subscribe to a service or program that includes a subscription that provides relocation information on frequently purchased items to the subscriber via a preferred channel such as text, email, phone message, or the like. In other embodiments, the customer can be prompted to subscribe to (or otherwise authorize) the service or program responsive to visiting the store via the in-store device, mobile phone, or other electronic device.

In some embodiments, the customer may be recognized as a frequent customer using an image recognition system that recognizes a customer as a frequent customer of the store based on historical image recognition data of the customer frequenting that store. Accordingly, in such systems, the customer may not be required to subscribe to the system that provides relocation information on frequently purchased items, rather the relocation information may be forwarded to the customer based on the recognition of the customer at the store and a pre-existing association of the recognized customer with, for example a loyalty program or other system that stores the customers purchase history.

In some embodiments, the frequently purchased items can be determined based on how frequently an item is purchased, the quantity of each item purchased, a pattern of purchases of the item, the time that has elapsed since the item was last purchased, or a combination of these factors. For example, the system may determine that a particular item is purchased about every third time that the customer visits the store. Accordingly, in some embodiments, the system may not provide item relocation information until it is likely that the customer is visiting the store to purchase that item. In still other embodiments, the system may base the timing of the relocation information on the portion size that was previously purchased. For example, if the customer purchased a half size of a particular item in a prior recent visit, the system may provide the relocation information for that item on the customer's next visit to the store despite a purchase pattern that indicates that the customer purchases a full-size version every third visit to the store.

In still other embodiments according to the invention, the relocation information for the frequently purchased items can include that the item is scheduled to be moved within the store in the future. For example, even though a customer's frequently purchased item has not yet been relocated, the recognized customer can be warned before the item is relocated so that when the recognized customer next visits the store, the customer already knows that the item has been moved. In such embodiments, the scheduled relocation information for the item can be provided to the recognized customer during the checkout process using, for example, a display that is also used to display purchase information, coupons, or input payment information. Accordingly, in such embodiments, the customer can be recognized using data input by the customer during the checkout-process. During the checkout process the customer may also be prompted to authorize a subscription to a service or loyalty program as part of provisioning the scheduled item relocation information. The customer may also input preferences for the service, such as the frequency of the reminders of the item relocation provided to the customer, the timing of the reminders (such as “when I next arrive at the store”), and/or the number of reminders, etc.

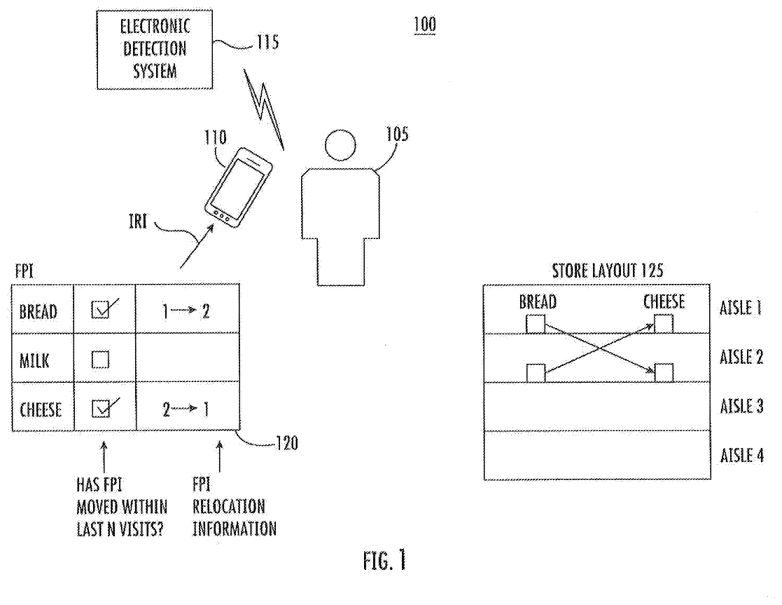

FIG. 1 is a schematic illustration of a system 100 configured to provide item relocation information (IRI) for frequently purchased items (FPI) to a recognized customer 105 via an electronic device 110 during a current presence of the customer 105 at a store in some embodiments according to the invention. According to FIG. 1, the customer 105 arrives at the store that has a particular store layout 125. The store layout 125 can be a representation of the physical locations of particular categories of items within the store, such as the relative locations of the categories bread and cheese. In addition, the store layout 125 can include indicia of the relocation of those categories which include items that are determined to be items frequently purchased by the customer 105. In some embodiments, historical purchase data associated with the customer 105 can indicate that the customer 105 purchased a particular brand of bread and a particular brand of cheese at certain dates and in certain quantities, which can be used to provide the basis for what items are frequently purchased (FPI). It will be understood that the customer may historically purchased different brands of items that are all included in the category of items that has been relocated within the store to provide the FPI.

When the customer 105 arrives at the store an electronic detection system 115 detects the current presence of customer 105. It will be understood the electronic detection system 115 can be any electronic system that is configured to detect the presence of the customer 105 at the store. According to FIG. 1, the electronic detection system 115 can recognize the presence of the customer 105 based on data received from the electronic device 110 (such as a mobile phone) that indicates that the electronic device 110 is within range of the electronic detection system 115 and is registered as associated with the customer 105 (via for example, a loyalty program or other system). In some embodiments the electronic device 110 is an electronic device provided in-store that may accept data from the customer 105, which can be used to recognize the customer 105 so that recognized customer data can be provided. It will be understood that the term “recognized customer data” can include where the identity of the customer within a database is established so that historical purchase information can be determined for the customer.

The recognized customer data can be used to access a database 120 that is configured to store historical purchase data associated with the recognized customer. The historical purchase data can be used to determine whether the recognized customer is a “frequent customer.” In some embodiments, the classification of a customer 105 as a frequent customer may be determined based on the number of times that the customer 105 has purchased items at the store, the quantity of items purchased each time (or in total), and/or the elapsed time since the customer 105 last visited the store, etc. It will be further understood that the term “recognized customer” can include the classification of the customer as a “frequent customer.” In other words, in some embodiments a “recognized customer” may be a customer that is identifiable and also meets the threshold requirements of a “frequent customer.”

The database 120 can store categories of items which may be relocated within the store. The database 120 may be updated when a category of items is relocated within the store. For example, as show in FIG. 1 the database 120 stores the categories: bread, milk, and cheese along with an indication for each whether that category of items has been recently relocated within the store as well as the relocation information for each category that has been relocated recently. It will be understood that the database 120 may store category relocation information for any number of stores as each store may locate and relocate categories independently. For example, as shown in FIG. 1, the database 120 shows that bread and cheese have been relocated recently. In particular, bread has moved from aisle 1 to aisle 2 whereas cheese has moved from aisle 2 to aisle 1. It will be further understood that a category may be indicated as being relocated recently based on a threshold level after which the category may no longer be indicated as “relocated.” For example, the threshold level for a relocated category may be specified as a number of days, a number of visits to the store for the recognized customer, etc. After the threshold is met or exceeded the category may not be indicated as “relocated.” It will be understood that the terms “item” and “category” are used herein interchangeably with one another as the movement of a category of items includes the movement of items within that category.

When a frequently purchased item for the recognized customer is determined as being relocated within the database 120, the relocation information for the frequently purchased item can be sent to the electronic device 110 so that the customer 105 is notified of the change before the customer is possibly frustrated by looking for the frequently purchased item in the previous location. For example, the relocation information for the frequently purchased item displayed by the electronic device 110 can include the graphical information shown in the store layout 125 so that the customer is guided to the new locations for the items which will likely be purchased. In some embodiments, the database 120 can also include a threshold for a number of times that the customer will be reminded of the items being relocated. For example, the database 120 may store data indicating that the relocation information will be provided for each item N times after which the item will be indicated as not relocated. In some embodiments, during the checkout process if any of the items for which the relocation data was provide to the customer were not purchased, the customer may be asked whether they would like to purchase that item. In some embodiments, a reminder may be provided via a checkout screen or via the electronic device 110.

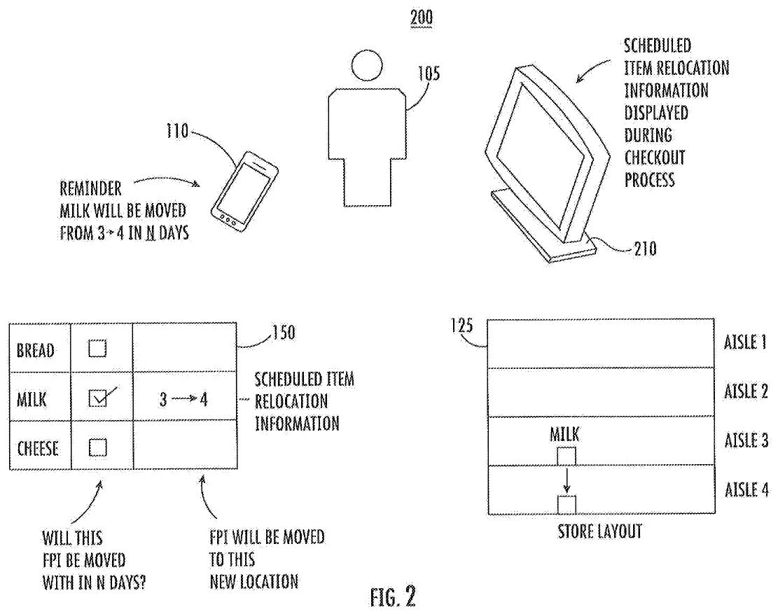

FIG. 2 is a schematic illustration of a system 200 configured to provide scheduled item relocation information (SIRI) for frequently purchased items (FPI) to a recognized customer 105 via an electronic device 210 during a checkout process at a store in some embodiments according to the invention. According to FIG. 2, a database 150 is configured to store an indication that a category of items is scheduled to be moved within the store. For example, the database 150 shows that milk is scheduled to be moved from aisle 3 to 4. It will be understood that the database 150 can also indicate a threshold for when the categories will be indicated as scheduled to move. In some embodiments, the database 150 may indicate that the category will move within a number of days. For example, the category may be scheduled to actually move in one month, but the database 150 may change the status to “scheduled to move” only after the schedule move date is within a certain number of days (such as 3 days). In some embodiments, the category may be scheduled to actually move in one month, but the database 150 may change the status to “scheduled to move” during the checkout process that is likely immediately before customer is predicted to next visit the store. In other words, the customer may be notified when checking out during the visit that is likely the last time that the item will be in the old location (i.e., the next time the customer visits the store the item will likely have already been moved).

When the scheduled item relocation information is provided to the electronic device 10, the information may include the graphical representation shown in the store layout 125 indicating that the milk will be moved from aisle 3 to aisle 4 as shown. Otherwise, the operations and components shown in FIG. 1 may also be used for the operations described in conjunction with FIG. 2.

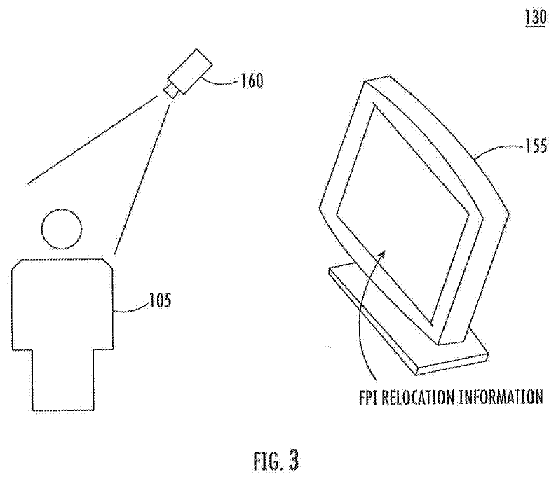

FIG. 3 is a schematic illustration of a system 130 configured to provide item relocation information (IRI) for frequently purchased items (FPI) to a recognized customer 105 via an electronic device 155 during a current presence of the customer 105 at a store in some embodiments according to the invention. According to FIG. 3, the customer 105 is recognized as being currently present at the store using an electronic detection system 160 that is configured to sample an image or video of the customer 105 (using a camera or other optical device) upon entering the store. The electronic detection system 160 can include an image recognition system that is configured to recognize biometric parameters of individuals for identification. The item relocation information can be provided to an in-store video monitor 155 that is viewable by the customer 105 and may include information that the customer can use to determine that the item relocation information being displayed is relevant to their visit, such as the customer's name. In some embodiments, only the item relocation information is displayed. In some embodiments, audio based item relocation information may also be played through the monitor. In other embodiments, a speaker may be used without the monitor. Otherwise, the operations and components shown in FIG. 1 may also be used for the operations described in conjunction with FIG. 3.

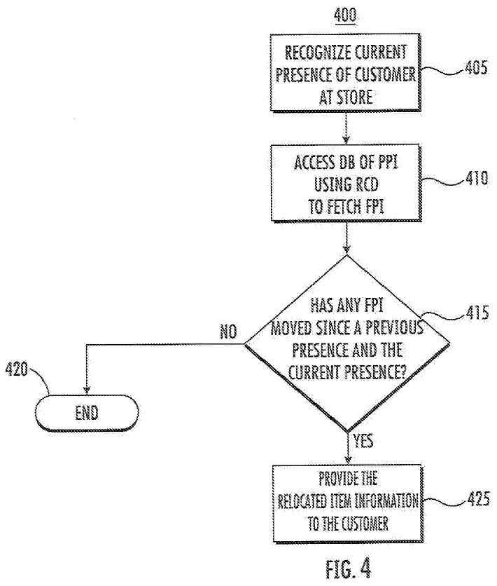

FIG. 4 is a flowchart illustrating methods of operating a system 400 configured to provide relocation information for frequently purchased items to a recognized customer in some embodiments according to the invention. According to FIG. 4, the current presence of the customer is recognized at the store (block 405) to provide recognized customer data (RCD). The recognized customer data is used to access the database to determine which of the previously purchased item (PPI) is a frequently purchased items (FPI) associated with the recognized customer (block 410).

A determination is made whether any of the frequently purchased items has been moved prior to the current presence of the customer at the store (block 415). The thresholds described herein can be utilized to indicate whether any of the frequently purchased items has been moved. If none of the frequently purchased items is determined to have been moved prior to the current presence of the customer at the store (block 415) processing may end (block 420). If any of the frequently purchased items is determined to have been moved prior to the current presence of the customer at the store (block 415), the item relocation information for each item moved is provided to the customer (block 425). The operations shown in FIG. 4 are provided until the customer indicates that the provisioning of the item relocation information should stop.

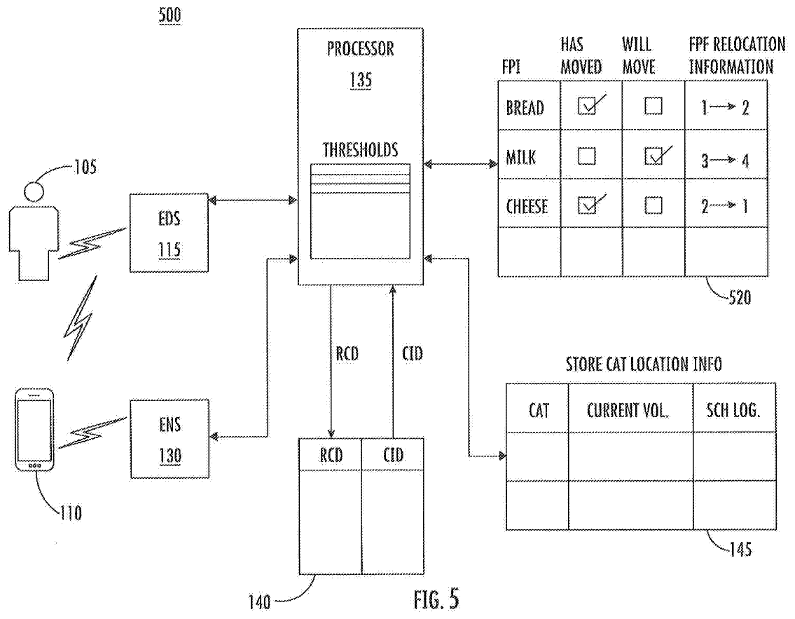

FIG. 5 is a block diagram of a system 500 configured to provide relocation information for frequently purchased items to a recognized customer in some embodiments according to the invention. According to FIG. 5, the electronic detection system 115 is configured to detect the presence of the customer 105 at the store. A processor circuit 135 is coupled to the electronic detection system 115 and is configured to use the data provided by the electronic detection system 115 to generate recognized customer data (RCD). The processor circuit 135 can use the RCD to access a database that includes customer identification (CID) information indexed to the RCD so that the processor circuit 135 can receive the CID information using the RCD. It will be understood that the CID information can be included in a customer loyalty system that stores historical purchase information for the customer.

The processor circuit 135 can use the CID information to access a database of store category location information 145 that indicates where the different categories of items are located in each store. The store category location information 145 can also include the new location for each category scheduled to be moved and the date for each of the moves. The processor circuit 135 can utilize the store category location information 145 to generate the data shown in the database 520 which represents a composite of the data shown in the databases 120 and 150. The processor circuit 135 can further transmit the item relocation information (and/or scheduled item relocation information) to the customer as described herein.

As described herein, frequent customers of a store can be frustrated when they are unable to find their frequently purchased items because those items have been moved within the store. Accordingly, methods, systems and articles of manufacture can advise recognized frequent customers that items that they have purchased frequently at that store have been moved. In some embodiments, relocation information for those frequently purchased items can be provided to the recognized customer via an electronic device. The electronic device may be provided by the store, may be a device associated or owned by the customer, or be an in-store device such as a video monitor or audio output device. The information may be text data, image data, video data, and/or audio data. For example, the relocation information may be a graphic that shows a representation of the store layout and depicts the movement of the item from one aisle to another.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. Elements described as being “to” perform functions, acts and/or operations may be configured to or other structured to do so.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wired, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages, such as a programming language for a FPGA, Verilog, System Verilog, Hardware Description language (HDL), and VHDL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

While the foregoing is directed to aspects of the present disclosure, other and further embodiments of the disclosure may be devised without departing from the basic scope thereof, and the scope thereof is determined by the claims that follow.

What is claimed:

1. A method of operating a shopping notification system comprising:
electronically recognizing a current presence of a customer at a store to provide recognized customer data;
accessing a database of previously purchased items of the customer using the recognized customer data to provide frequently purchased items information associated with the customer,
electronically determining that a category of items including any item in the frequently purchased items information has moved within the store in a time between a previous presence of the customer at the store and the current presence of the customer at the store to provide item relocation information; and
electronically providing the item relocation information to the customer.

2. The method of claim 1 wherein electronically recognizing the current presence of the customer at the store to provide the recognized customer data comprises:
receiving data from an electronic device associated with the customer during the current presence of the customer at the store; and
wherein electronically providing the item relocation information to the customer comprises sending a message to the electronic device during the current presence of the customer at the store.

3. The method of claim 1 wherein electronically recognizing the current presence of the customer at the store to provide the recognized customer data comprises receiving image data from an in-store electronic imaging device during the current presence of the customer at the store; and
electronically providing the item relocation information to the customer via audio or via video during the current presence of the customer at the store.

4. The method of claim 1 wherein electronically determining that the category of items including any item in the frequently purchased items information has moved between the previous presence of the customer at the store and the current presence of the customer at the store to provide the item relocation information comprises:
determining that the category of items including any item in the frequently purchased items information has moved between the previous presence of the customer at the store and before the current presence of the customer at the store to provide the item relocation information.

5. The method of claim 4 wherein electronically providing the item relocation information to the customer comprises electronically providing the item relocation information to the customer comprises sending a message including the item relocation information to an electronic device associated with the customer before the current presence of the customer at the store.

6. The method of claim 4 wherein electronically providing the item relocation information to the customer comprises electronically providing the item relocation information to the customer comprises sending an image including the item relocation information to an electronic device associated with the customer before the current presence of the customer at the store.

7. The method of claim 1 wherein accessing the database of previously purchased items using the recognized customer data to provide the frequently purchased items information associated with the customer comprises including an item in the frequently purchased items information if the item has been purchased more than a threshold number of times at the store and has been most recently purchased by the customer at the store in less than a threshold time.

8. The method of claim 1 wherein the item relocation information comprises a new location for the category of items.

9. The method of claim 8 wherein the item relocation information further comprises an indication of a new category that has replaced the category of items at a previous location of the category of items.

10. The method of claim 1 further comprising:
and then repeating each preceding operation until the customer provides an indication to stop repeating each preceding operation.

11. A method of operating an electronic shopping notification system comprising:
electronically recognizing a current presence of a customer at a store during a checkout process to provide recognized customer data;
accessing a database of previously purchased items of the customer using the recognized customer data to provide frequently purchased items information associated with the customer,
electronically determining that a category of items including any item in the frequently purchased items information is scheduled to be moved within the store after the current presence to provide scheduled item relocation information; and
electronically displaying the scheduled item relocation information to the customer.

12. The method of claim 11 further comprising:
prompting the customer during the checkout process for timing of the scheduled item relocation information.

13. The method of claim 12 wherein electronically displaying the scheduled item relocation information to the customer comprises a message sent to an electronic device associated with the customer.

14. The method of claim 13 further comprising:
requesting authorization from the customer during the checkout process to subscribe the customer to receive the message.

15. The method of claim 14 further comprising:
requesting preferences for the message from the customer during the checkout process for a customer profile.

16. A shopping notification system comprising:
an electronic detection system configured to electronically receive data associated with an identity of a customer responsive to a current presence of the customer at a store to provide recognized customer data;
a database, coupled to the electronic detection system, configured to store previously purchased items of the customer accessed using the recognized customer data to provide frequently purchased items information associated with the customer;
a processor circuit, coupled to the database and the electronic detection system, the processor circuit configured to determine that a category of items including any item in the frequently purchased items information has moved in a time between a previous presence of the customer at the store and the current presence of the customer at the store to provide item relocation information; and
an electronic notification system, coupled to the processor circuit and configured to provide the item relocation information to the customer.

17. The system of claim 16 wherein the electronic detection system comprises a receiver configured to receive data from an electronic device associated with the customer during the current presence of the customer at the store; and
wherein the electronic notification system is configured to provide the item relocation information to the customer including sending a message to the electronic device during the current presence of the customer at the store.

18. The system of claim 16 wherein the electronic detection system is configured to detect the current presence of the customer at the store by receiving image data from an in-store electronic imaging device during the current presence of the customer at the store and
wherein the electronic notification system comprises an electronic audio or video device configured to transmit the item relocation information to the customer via audio or via video during the current presence of the customer at the store.

19. The system of claim 16 wherein the processor circuit is further configured to determine that the category of items including any item in the frequently purchased items information has moved in the store between the previous presence of the customer at the store and before the current presence of the customer at the store to provide the item relocation information.

20. The system of claim 16 wherein the processor circuit is configured to access the database using the recognized customer data to provide an item in the frequently purchased items information if the item has been purchased more than a threshold number of times at the store and has been most recently purchased by the customer at the store in less than a threshold time.
